(19) United States
(12) Patent Application Publication
(10) Pub. No.: US 2016/0238041 A1
(43) Pub. Date: Aug. 18, 2016

(54) Hydraulic Pressure Circuit and Working Machine

(71) Applicant: CATERPILLAR SARL, Geneva (CH)

(72) Inventors: Shigeo Kajita, Tokyo (JP); Kouji Kishida, Tokyo (JP); Yuya Kanenawa, Tokyo (JP); Shogo Tada, Tokyo (JP); Yoshihiko Hata, Tokyo (JP); Nobuaki Matoba, Hyogo (JP)

(73) Assignee: Caterpillar SARL, Geneva (CH)

(21) Appl. No.: 15/031,616

(22) PCT Filed: Nov. 4, 2014
(86) PCT No.: PCT/EP2014/073734

§ 371 Date: Apr. 22, 2016

(30) Foreign Application Priority Data
Nov. 6, 2013 (JP) 2013-230533

(51) Int. Cl. F15B 11/024; E02F 3/42; E02F 9/22; F15B 1/02; F15B 21/14

(52) U.S. Cl. CPC F15B 11/024; F15B 1/024; F15B 21/14; E02F 9/2217; E02F 3/425; F15B 2211/212; E02F 3/32

(57) ABSTRACT

Provided is a hydraulic circuit capable of saving a pump flow rate while hydraulic fluid is being accumulated in an accumulator. The hydraulic circuit has: a couple of boom cylinders that simultaneously operate the same operation by the hydraulic oil supplied under pressure from main pumps; an accumulator in which pressure of the hydraulic oil is accumulated; a pressure accumulating circuit that accumulates the pressure of the hydraulic oil extruded from one boom cylinder in the accumulator; and a regenerating circuit that regenerates the hydraulic oil extruded from the other boom cylinder to the boom cylinders.

### TECHNICAL FIELD

The present invention relates to a hydraulic pressure circuit including an accumulator and to a working machine provided with the hydraulic pressure circuit.

### BACKGROUND ART

In working machines, pressure oil discharged from a boom hydraulic cylinder when a boom is lowered is accumulated in an accumulator, and pressure oil relieved from a swinging hydraulic motor when swinging is accelerated or decelerated is also accumulated in the accumulator (see Patent Document 1, for example).

[Patent Document 1] Japanese Patent Application Laid-open No. 2010-84888

While the pressure oil discharged from the boom hydraulic cylinder is being accumulated in the accumulator, the pressure oil discharged from the boom hydraulic cylinder cannot be recovered to the boom hydraulic cylinder. Thus, the required pump flow amount might be failed to be secured and an operation of the boom hydraulic

### DISCLOSURE OF THE INVENTION

The present invention is made in view of such a point, and an object of the present invention is to provide a hydraulic pressure circuit and a working machine that can secure a required pump flow amount even when hydraulic oil is being accumulated in an accumulator.

An invention according to claim 1 is a hydraulic pressure circuit including: a plurality of fluid pressure cylinders performing the same operation at the same time by a hydraulic fluid pressurized and supplied from a pump; an accumulator in which the hydraulic fluid is accumulated; an accumulating circuit for accumulating, in the accumulator, the hydraulic fluid pushed out of one fluid pressure cylinder among the plurality of fluid pressure cylinders; and a recovering circuit that recovers the hydraulic fluid pushed out of another fluid pressure cylinder that is different from the one fluid pressure cylinder, among the plurality of fluid pressure cylinders, to the other fluid pressure cylinder.

An invention according to claim 2 is the hydraulic pressure circuit according to claim 1 further including a combination valve formed of a single block incorporating a plurality of circuit functions that switch among the accumulating circuit, the recovering circuit, and a circuit that guides the hydraulic fluid pressurized and supplied from the pump to the plurality of fluid pressure cylinders.

An invention according to claim 3 is a working machine including: a vehicle body; a working apparatus mounted on the vehicle body; and the hydraulic pressure circuit according to claim 1 or 2 provided for a plurality of fluid pressure cylinders that raise and lower the working apparatus.

In the invention according to claim 1, the accumulating circuit and the recovering circuit are separated from each other and the hydraulic fluid pushed out of the one fluid pressure cylinder is accumulated in the accumulator. At the same time, the hydraulic fluid pushed out of the other fluid pressure cylinder is recovered. Thus, even during the accumulation of the accumulator, the pump flow amount can be saved by an amount corresponding to the recovered flow amount, whereby the required pump flow amount can be easily secured, and the pump can be downsized. A load is not distributed to all of the plurality of fluid pressure cylinders and is concentrated to a smaller number of fluid pressure cylinders. Thus, pressure produced from the fluid pressure cylinder can be raised to increase energy accumulated in the accumulator, whereby the accumulator can be downsized.

In the invention according to claim 2, the combination valve is formed of a single block incorporating the plurality of circuit functions that switch among the accumulating circuit, the recovering circuit, and the circuit that guides the hydraulic fluid pressurized and supplied from the pump to the plurality of fluid pressure cylinders. Thus, a simple layout can be achieved and the cost can be reduced.

In the invention according to claim 3, even during the accumulation operation of the accumulator when the working apparatus of the working machine is lowered, the pump flow amount can be saved by an amount corresponding to the recovered flow amount, whereby the required pump flow amount can be easily secured, and the pump can be downsized. The load is not distributed to all of the plurality of fluid pressure cylinders and is concentrated to a smaller number of fluid pressure cylinders. Thus, pressure produced from the fluid pressure cylinder can be raised to increase energy accumulated in the accumulator, whereby the accumulator can be downsized.

### BRIEF DESCRIPTION OF THE DRAWINGS

FIG. 1 is a circuit diagram showing an embodiment of a hydraulic pressure circuit according to the present invention.

FIG. 2 is a circuit diagram showing a switched state of the circuit.

FIG. 3 is a circuit diagram showing another switched state of the circuit.

FIG. 4 is a perspective view of an embodiment of a working machine according to the present invention.

### BEST MODE FOR CARRYING OUT THE INVENTION

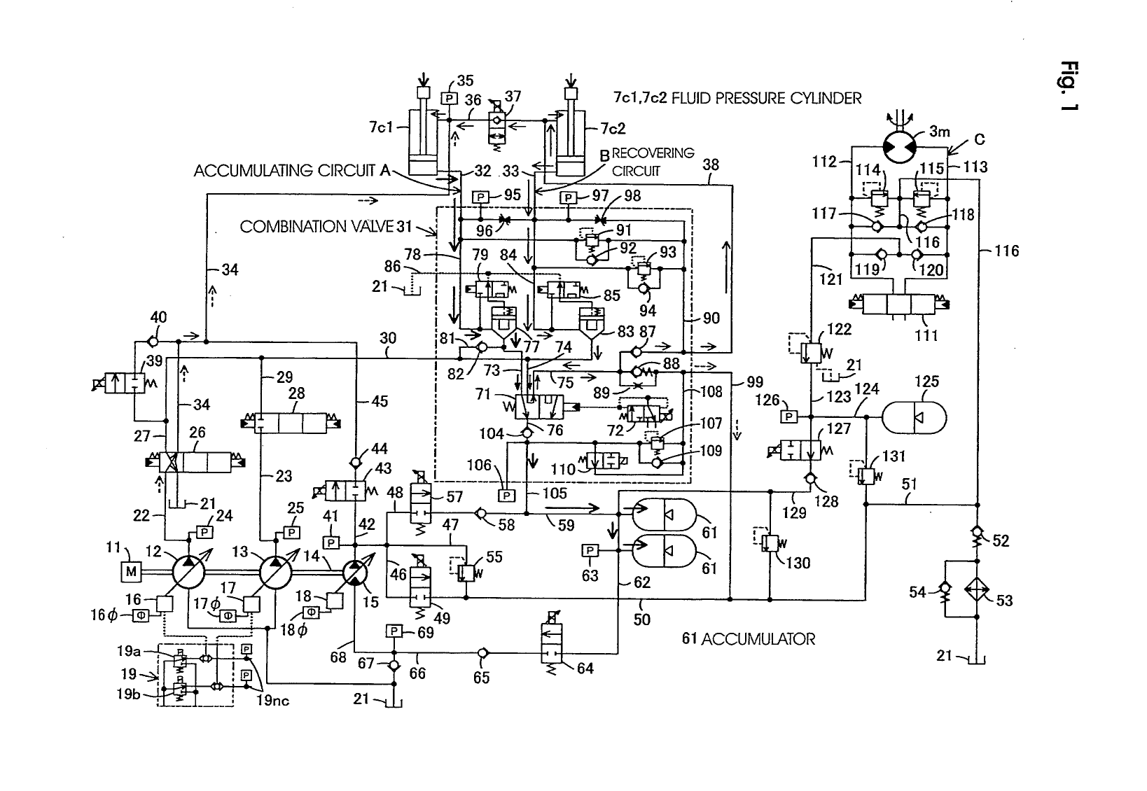

The present invention will be described in detail below based on an embodiment shown in FIGS. 1 to 4.

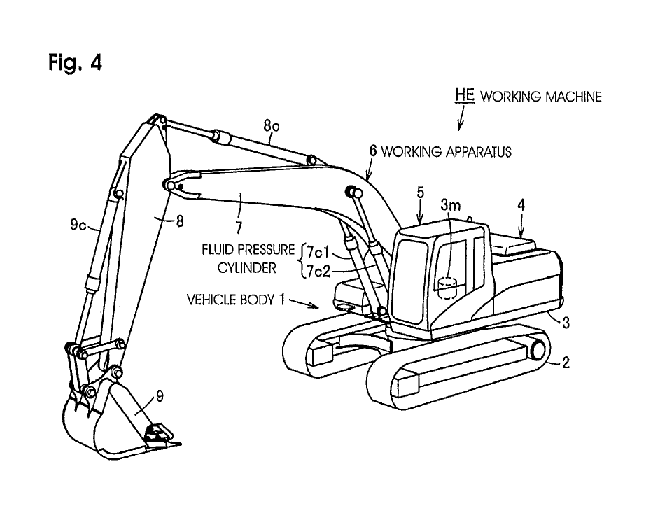

As shown in FIG. 4, a hydraulic shovel HE as a working machine has a vehicle body 1 formed of a lower traveling body 2 and an upper swinging body 3 disposed on the lower traveling body 2 to be capable of being swung by a swinging motor 3m. A machine chamber 4, a cab 5, and a working apparatus 6 are mounted on the upper swinging body 3. An engine and a pump are mounted in the machine chamber 4. The cab 5 protects an operator.

The working apparatus 6 has the following configuration. Specifically, a base end of a boom 7 is pivotally supported by the upper swinging body 3. The boom 7 is rotated in an up and down direction by two boom cylinders 7c1 and 7c2 which are fluid pressure cylinders arranged in parallel. A stick 8 is pivotally supported by a distal end of the boom 7. The stick 8 is rotated in a front and rear direction by a stick cylinder 8c. A bucket 9 is pivotally supported by a distal end of the stick 8. The bucket 9 is rotated by a bucket cylinder 9c. The two boom cylinders 7c1 and 7c2 are arranged in parallel for the common boom 7, and perform the same operation at the same time.

FIG. 1 shows an engine power assist system. The engine power assist system makes potential energy of the working apparatus 6 and kinetic energy of the upper swinging body 3 accumulated into an accumulator, respectively through the boom cylinder 7c1 and the swinging motor 3m. The energy thus accumulated is used for assisting engine power.

Next, a circuit configuration of this system will be described.

An assist pump motor 15 is coupled, directly or through a gear, to a main pump shaft 14 of main pumps 12 and 13 which are pumps driven by a mounted engine 11 in the machine chamber 4. The main pumps 12 and 13 and the assist pump motor 15 each includes a swash plate. A pump/motor capacity (piston stroke) can be variably adjusted with an angle of the swash plate. The swash plate angles (tilt angles) are controlled by regulators 16, 17, and 18 and are detected by swash plate angle sensors 16φ, 17φ, and 18φ. The regulators 16, 17, and 18 are controlled by a solenoid valve. For example, the regulators 16 and 17 of the respective main pumps 12 and 13 can be automatically controlled by a negative flow control pressure (what is known as negative control pressure) guided through a negative flow control path 19nc. The regulators 16 and 17 may also be controlled by a signal other than the negative control pressure, by electromagnetic switching valves 19a and 19b of a negative flow control valve 19.

The main pumps 12 and 13 discharge hydraulic oil, which is a hydraulic fluid sucked from a tank 21, respectively to paths 22 and 23. Pressure sensors 24 and 25 detect the discharge pressure of the pumps. Output paths 27 and 29 are connected to a boom energy recovery valve 31 that is a combination valve, through a path 30. The output paths 27 and 29 respectively extend from main and sub boom control valves 26 and 28 for controlling the boom cylinders 7c1 and 7c2. The main and sub boom control valves 26 and 28 are pilot operated control valves that are connected to the main pumps 12 and 13 and control the direction and the flow amount.

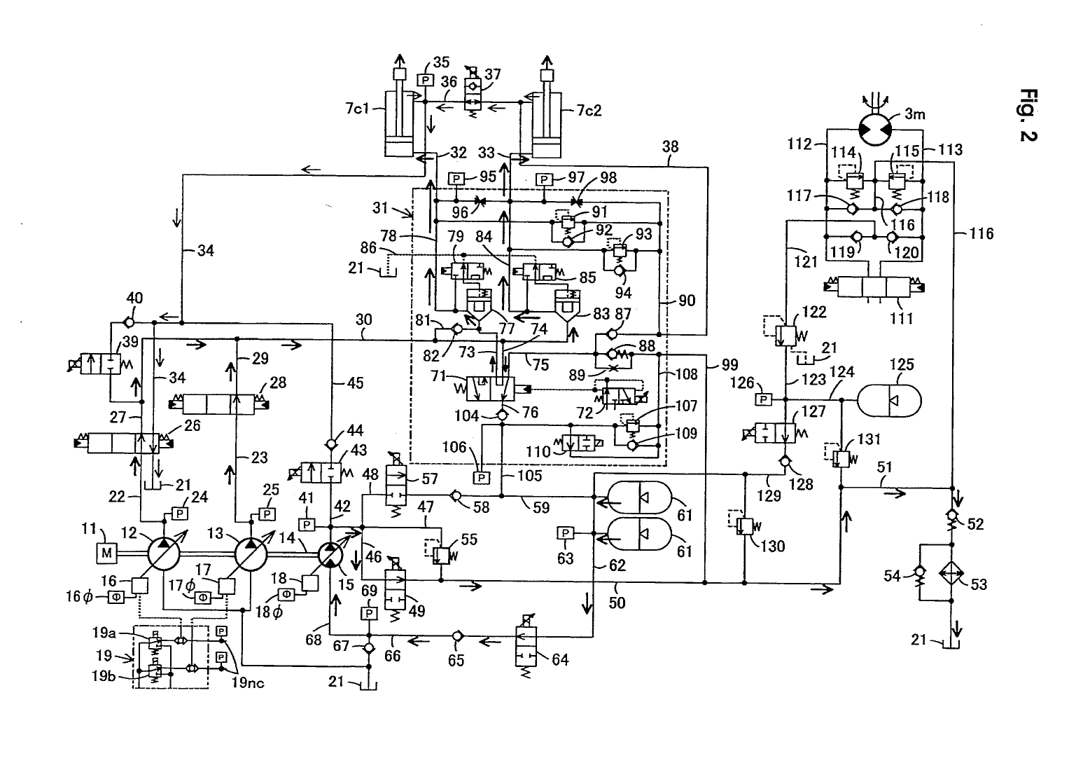

The boom energy recovery valve 31 is a combination valve formed of a single block incorporating a plurality of circuit functions for switching among an accumulating circuit A and a recovering circuit B shown in FIG. 1 and a circuit shown in FIG. 2. The circuit shown in FIG. 2 guides the hydraulic oil pressurized and supplied from the main pumps 12 and 13, during the boom raising operation, to head sides of the two boom cylinders 7c1 and 7c2.

Head side ends of the one boom cylinder 7c1 and the other boom cylinder 7c2 are connected to the boom energy recovery valve 31 respectively through paths 32 and 33. The other output path 34, extending from the main boom control valve 26, is connected to a rod side end of the one boom cylinder 7c1. A pressure sensor 35 that detects boom cylinder rod side pressure is disposed on the rod side end. The rod side ends of the two boom cylinders 7c1 and 7c2, which are arranged in parallel, can communicate with each other through a bypass path 36. An electromagnetic separation valve 37 provided in the bypass path 36 can block the communication from the rod side of the boom cylinder 7c1 to the rod side of the boom cylinder 7c2. The rod side of the boom cylinder 7c2 is connected to the boom energy recovery valve 31 through a path 38.

The one output path 27 extending from the main boom control valve 26 can communicate with the other output path 34 through an electromagnetic switching valve 39 and a check valve 40. A pressure sensor 41 is disposed on a discharge side of the assist pump motor 15, and detects the discharge pressure. A discharge path 42 of the assist pump motor 15 is provided with an electromagnetic switching valve 43. A path 45 passing through a check valve 44 is connected to the output path 34.

The discharge path 42 of the assist pump motor 15 is branched into three paths 46, 47, and 48. The path 46 is connected to an electromagnetic unload valve 49. The electromagnetic unload valve 49 is connected to the tank 21 through tank paths 50 and 51 as well as a spring equipped check valve 52 and an oil cooler 53 or a spring equipped check valve 54. The path 47 is connected to the tank path 50 through a relief valve 55.

The path 48 is connected to an accumulator path 62 provided with a plurality of first accumulators 61 through an electromagnetic switching valve 57, a check valve 58, and a path 59. A pressure sensor 63 that detects the pressure accumulated in the first accumulator 61 is connected to the accumulator path 62. The accumulator path 62 is connected to a path 66 passing through an electromagnetic recovery valve 64 and a check valve 65. The path 66 is connected to an intake side path 68 extending from the tank 21 and connected to an intake port of the assist pump motor 15 through a check valve 67. A pressure sensor 69 that detects the assist pump motor intake side pressure is disposed on the intake side path 68.

The assist pump motor 15 has the following functions. Specifically, when the pressure accumulated in the first accumulator 61 increases and the accumulator pressure reaches a predetermined value, the electromagnetic recovery valve 64 is switched to a communication position, and thus the hydraulic oil is sucked from the first accumulator 61, whereby pressure rise in the first accumulator 61 can be prevented. At the same time, the hydraulic oil thus sucked is pressurized and supplied to the rod side of the boom cylinder 7c1.

The boom energy recovery valve 31 includes a pilot operated main switching valve 71. The main switching valve 71 controls the supply and discharge of pilot pressure with an electromagnetic switching valve 72 to switch the relationship among paths 73, 74, 75, and 76.

The path 73 is connected to one port of one drift reducing valve 77. The outer path 32, extending from the head side end of the one boom cylinder 7c1, is connected to the other port of the drift reducing valve 77 through an inner path 78. The drift reducing valve 77 controls the pilot pressure in a spring chamber with a pilot valve 79, to control the opening/closing and an opening amount between the ports. A path 81, branched off from the path 30, is connected to the path 73 through a check valve 82.

The path 74 is connected to the path 30, and is further connected to one port of the other drift reducing valve 83. The outer path 33, extending from the head side end of the other boom cylinder 7c2, is connected to the other port of the drift reducing valve 83 through an inner path 84. The drift reducing valve 83 controls the pilot pressure in the spring chamber with a pilot valve 85 to control the opening/closing and an opening amount between the ports.

The spring chambers of the drift reducing valves 77 and 83 are in communication with the paths 78 and 84, or with the path 86 to the tank 21 through the pilot valve 79 or 85.

The path 75 is branched into paths to a check valve 87, to a spring equipped check valve 88, and to a variable throttle valve 89. The path passing through the check valve 87 is connected to the outer path 38 and an inner path 90. A relief valve 91 and a check valve 92 are disposed between the path 90 and the path 78. A relief valve 93 and a check valve 94 are disposed between the path 90 and the path 84. A pressure sensor 95 and a regulating valve 96 are disposed between the paths 78 and the path 84. A pressure sensor 97 and a regulating valve 98 are disposed between the path 84 and the path 90. The spring equipped check valve 88 and the variable throttle valve 89 are connected to the tank path 50 through a path 99.

The path 76 is connected to the path 59 through a path 105 passing through a check valve 104. A pressure sensor 106 detects the pressure in the path 105. A path branched off from the path 105 is connected to the tank path 50 through a relief valve 107, a path 108, and the path 99. The path 108 is in communication with the path 105 through the check valve 109. The path 105 is connected to the path 108 through an electromagnetic switching valve 110.

As shown in FIG. 1, the accumulating circuit A is a circuit leading to the first accumulator 61 through the path 32 extending from the head side end of the one boom cylinder 7c1, and through the path 78, the drift reducing valve 77, the path 73, the main switching valve 71, the check valve 104, and the path 105 that are in the boom energy recovery valve 31. The accumulating circuit A has a function of accumulating the oil pushed out of the head side of the boom cylinder 7c1 into the first accumulator 61.

As shown in FIG. 1, the recovering circuit B is a circuit leading to the rod side end of the other boom cylinder 7c2 through the path 33 extending from the head side end of the other boom cylinder 7c2 and through the path 84, the drift reducing valve 83, the path 74, the main switching valve 71, the path 75, the check valve 87, and the path 38 that are in the boom energy recovery valve 31. The recovering circuit B has a function of recovering the oil pushed out of the head side of the boom cylinder 7c2 to the rod side of the boom cylinder 7c2.

Relief valves 114 and 115 oriented in opposite directions as well as check valves 117 and 118 oriented in opposite directions are disposed between paths 112 and 113 of a motor driving circuit C that connect the swinging motor 3m and a swing control valve 111 for controlling the direction and the speed of the swinging of the swinging motor 3m. A makeup path 116 is connected between the relief valves 114 and 115, and the check valves 117 and 118. The makeup path 116 has a tank path function of returning the oil discharged from the motor driving circuit C to the tank 21. The makeup path 116 also has a makeup function with which the hydraulic oil can be supplied to the motor driving circuit C. The hydraulic oil is supplied to the path 112 or 113, on aside where vacuum might be produced, from the makeup path 116 through the check valve 117 or 118, at the pressure not exceeding the spring biasing pressure of the spring equipped check valve 52.

The paths 112 and 113 of the motor driving circuit C are in communication with a path 121 for recovering swinging energy, through the check valves 119 and 120. The path 121 is connected to a path 123 through a sequence valve 122. The source pressure on the input side of the sequence valve 122 is less likely to change due to the back pressure on the output side. The path 121 is further connected to a second accumulator 125 through a path 124. A pressure sensor 126 detects the pressure related to the second accumulator 125. The path 123 is connected to the accumulator path 62 of the first accumulator 61 through a path 129 passing through an electromagnetic switching valve 127 and a check valve 128. The path 129 is connected to the tank path 50 through a relief valve 130. The second accumulator 125 is connected to the tank path 51 through a relief valve 131.

When the swinging by the swinging motor 3m is accelerated and stopped, the driving energy and the braking energy relieved through the relief valves 114 and 115 are converted into the pressure to be accumulated in the second accumulator 125 before the relief valves 114 and 115 operate. Thus, the relieved swinging energy is recovered. In an assist mode, the electromagnetic switching valve 127 and the electromagnetic recovery valve 64 are switched to the communication position. Thus, the pressure oil discharged from the second accumulator 125 is pressurized and supplied to the assist pump motor 15, through the accumulator path 62 and the electromagnetic recovery valve 64 on the side of the first accumulator 61. The assist pump motor 15 is driven as a hydraulic motor to assist hydraulic outputs from the main pumps 12 and 13, thereby reducing an engine load.

The vacuum might be produced on the upstream side of the swinging motor 3m, when the swing stop energy is supplied to the second accumulator 125. Thus, the electromagnetic unload valve 49 is opened when the swinging operation starts, and the swash plate angle of the assist pump motor 15 is controlled in accordance with the amount and the speed of the swinging operation lever operation. Thus, the hydraulic oil is supplied to a path in which the vacuum is likely to be produced in the motor driving circuit C, from the assist pump motor 15 through the electromagnetic unload valve 49, the tank paths 50 and 51, and the makeup path 116, by a flow amount corresponding to the amount and the speed of the swinging operation lever operation.

In the circuit configuration described above, the swash plate angle sensors 16φ, 17φ, and 18φ as well as the pressure sensors 24, 25, 35, 41, 63, 69, 95, 97, 106, and 126 input the detected swash plate angle signals and the pressure signals to an on-board controller (not shown). The electromagnetic switching valves 39, 43, 57, 72, 110, and 127 as well as the electromagnetic unload valve 49 and the electromagnetic recovery valve 64 perform an ON/OFF operation in accordance with a driving signal output from the on-board controller (not shown) or are switched through a proportional action corresponding to the driving signal. A pilot operation is performed on the boom control valves 26 and 28, the swing control valve 111, and other unillustrated hydraulic actuator control valves (for the drive motor, the stick cylinder, the bucket cylinder, and the like), through a manual operation valve, known as a remote control valve, operated by an operator in the cab 5 through a lever or a pedal. The pilot operation on the drift reducing valves 77 and 83 as well as the pilot valves 79 and 85 is performed in conjunction with the pilot operation.

The control performed by the on-board controller is described below as a function.

(Engine Power Assist Function)

An engine power assist function in the hydraulic pressure circuit having the configuration described above will be described.

FIG. 1 shows a circuit state at the time of boom lowering operation for lowering the boom 7. The hydraulic oil, pushed out of the head side of the one boom cylinder 7c1 to the paths 32 and 78 by the load of the working apparatus 6 and the like, passes through the drift reducing valve 77 of the boom energy recovery valve 31 and then has the direction controlled by the main switching valve 71 to move from the path 73 to the path 76. Then, the hydraulic oil passes through the paths 105 and 59 to be accumulated in the first accumulator 61.

At the same time, the hydraulic oil pushed out of the head side of the other boom cylinder 7c2 to the paths 33 and 84 passes through the drift reducing valve 83 of the boom energy recovery valve 31 and then has the direction controlled by the main switching valve 71 to move from the path 74 to the path 75. Then, the hydraulic oil passes through the check valve 87 and the path 38 to be recovered to the rod side of the other boom cylinder 7c2. Depending on the rod side pressure balance between the one and the other boom cylinders 7c1 and 7c2, the hydraulic oil is also recovered to the rod side of the one boom cylinder 7c1 through the check valve in the electromagnetic separation valve 37.

As described above, when the boom is lowered, the boom energy recovery valve 31 performs the accumulation into the first accumulator 61 and the recovering to the rod sides of the boom cylinders 7c1 and 7c2 through the main switching valve 71 and the drift reducing valves 77 and 83.

FIG. 2 shows a circuit state at the time of boom raising operation for raising the boom 7. At the time of boom raising operation, the boom energy recovery valve 31 stops the pressure accumulation into the first accumulator 61 and the recovering to the rod sides of the boom cylinders 7c1 and 7c2. The hydraulic oil, supplied to the path 30 through the boom control valves 26 and 28 from the main pumps 12 and 13, has the direction controlled by the main switching valve 71 subjected to the switching operation to move from the path 74 to the path 73. Thus, the hydraulic oil is guided to the head sides of both of the boom cylinders 7c1 and 7c2 from the paths 73 and 30 through the drift reducing valves 77 and 83.

Here, the assist pump motor 15, which has pump and motor functions and is coupled to the main pump shaft 14 directly or through a gear, functions as a hydraulic motor as shown in FIG. 2 through the following operation. Specifically, the electromagnetic unload valve 49 and the electromagnetic recovery valve 64 are switched to the communication position. The assist pump motor 15 is rotated by the energy accumulated in the first accumulator 61. Thus, the hydraulic outputs of the main pumps 12 and 13 are assisted, whereby the engine load is reduced.

As described above, the engine power assist function is as follows. Specifically, the assist pump motor 15 is rotated as the hydraulic motor by the energy that is accumulated in the first accumulator 61 from the head side of the one boom cylinder 7c1. Thus, the assist pump motor 15 reduces the load on the mounted engine 11 coupled through the main pump shaft 14.

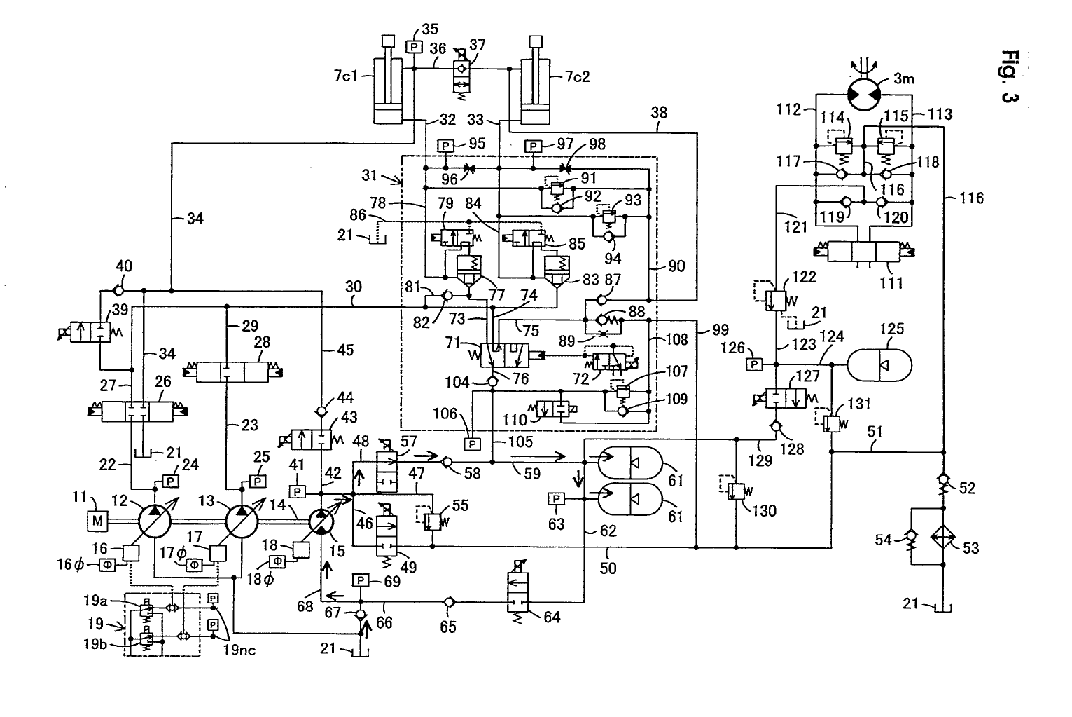

FIG. 3 shows a circuit state in a case where the engine load is small. The electromagnetic switching valve 57 is switched to the communication position, whereby the assist pump motor 15 functions as the hydraulic pump. Thus, the hydraulic oil pumped up from the tank 21 is supplied to and thus accumulated in the first accumulator 61.

An effect of the engine power assist function is described.

Head side oil of the boom cylinder 7c1 on one side is accumulated in the first accumulator 61. Thus, the load of the working apparatus 6 is concentrated to one boom cylinder 7c1 instead of being distributed to the two boom cylinders 7c1 and 7c2. Thus, the energy density can be increased, whereby the pressure produced from the boom cylinder 7c1 is raised to increase the energy accumulated in the first accumulator 61. In other words, the components such as the first accumulator 61 and the assist pump motor 15 can be downsized, whereby the cost reduction and a simple layout can be achieved.

When the boom cylinders 7c1 and 7c2 and the other hydraulic actuator (such as the swinging motor 3m, the stick cylinder 8c, and the bucket cylinder 9c) are operated in conjunction with each other, the hydraulic oil pushed out of the head side of the boom cylinder 7c2 on one side is recovered to the rod sides of the boom cylinders 7c1 and 7c2. Thus, the recovered amount of hydraulic oil can be provided to the other hydraulic actuators from the main pumps 12 and 13. Thus, the speed drop in the conjunctive operation can be prevented, whereby the conjunctive operation can be facilitated.

When the accumulation circuit A and the recovering circuit B are separated from each other and the working apparatus 6 of the hydraulic shovel HE is lowered, the hydraulic oil pushed out of the head side of the one boom cylinder 7c1 is accumulated in the first accumulator 61. At the same time, the hydraulic oil pushed out of the head side of the other boom cylinder 7c2 is recovered to the rod sides of the boom cylinders 7c1 and 7c2. Thus, even during the accumulation operation for the first accumulator 61, the main pump flow amount can be saved by an amount corresponding to the recovered flow amount. As a result, the required pump flow amount including the main pump flow amount required in the other hydraulic actuators can be readily secured, and the pumps 12 and 13 can be downsized.

The boom energy recovery valve 31 is formed of a single block incorporating a plurality of circuit functions in a concentrated manner, whereby a simple layout can be achieved and the cost can be reduced with a smaller number of assembly steps.

The assist pump motor 15 selectively uses the pump or the motor function in accordance with the engine load. Thus, the engine load can be balanced, and the energy can be stored in the first accumulator 61 from the mounted engine 11 which has energy to spare, to be used for assisting the engine load when required. Thus, an exhaust gas post-processing apparatus for reducing the exhaust gas of the mounted engine 11 can be downsized. The load is concentrated to the one boom cylinder 7c1, whereby the energy accumulated in the first accumulator 61 can be increased. Thus, high level assisting can be achieved with a small accumulator, whereby the cost can be reduced and a compact vehicle body layout can be achieved.

### INDUSTRIAL APPLICABILITY

The present invention has industrial applicability for companies involved in manufacturing, selling, and the like of hydraulic pressure circuits or working machines.

### EXPLANATION OF REFERENCE NUMERALS

A accumulating circuit
B recovering circuit
HE hydraulic shovel as working machine
1 vehicle body
6 working apparatus
7c1, 7c2 boom cylinder as fluid pressure cylinder
12, 13 main pump as pump
31 boom energy recovery valve as combination valve
61 accumulator

1. A hydraulic pressure circuit comprising:
a plurality of fluid pressure cylinders performing the same operation at the same time by a hydraulic fluid pressurized and. supplied from a pump;
an accumulator in which the hydraulic fluid is accumulated;
an accumulating circuit for accumulating, in the accumulator, the hydraulic fluid pushed out of one fluid pressure cylinder among the plurality of fluid pressure cylinders; and
a recovering circuit that recovers the hydraulic fluid pushed out of another fluid pressure cylinder that is different from the one fluid pressure cylinder, among the plurality of fluid pressure cylinders, to the other fluid pressure cylinder.

2. The hydraulic pressure circuit according to claim 1, further comprising a combination valve formed of a single block incorporating a plurality of circuit functions that switch among the accumulating circuit, the recovering circuit, and a circuit that guides the hydraulic fluid pressurized and supplied from the pump to the plurality of fluid pressure cylinders.

3. A working machine comprising:
a vehicle body;
a working apparatus mounted on the vehicle body; and
the hydraulic pressure circuit according to claim 1, provided for a plurality of fluid pressure cylinders that raise and lower the working apparatus.

4. A working machine comprising:
a vehicle body;
a working apparatus mounted on the vehicle body; and
the hydraulic pressure circuit according to claim 2, provided for a plurality of fluid pressure cylinders that raise and lower the working apparatus.
